(19) United States
(12) Patent Application Publication
(10) Pub. No.: US 2017/0279821 A1
(43) Pub. Date: Sep. 28, 2017

(54) SYSTEM AND METHOD FOR DETECTING INSTRUCTION SEQUENCES OF INTEREST

(71) Applicant: TrustPipe LLC, Healdsburg, CA (US)

(72) Inventors: John S. FLOWERS, San Francisco, CA (US); Martin QUIROGA, Healdsburg, CA (US)

(73) Assignee: TrustPipe LLC, Healdsburg, CA (US)

(21) Appl. No.: 15/465,446

(22) Filed: Mar. 21, 2017

Related U.S. Application Data
(60) Provisional application No. 62/311,840, filed on Mar. 22, 2016.

(51) Int. Cl. H04L 29/06; G06F 9/30

(52) U.S. Cl. CPC H04L 63/1416; G06F 9/30145; H04L 63/1433

(57) ABSTRACT

An instruction sequence detection system is trained to detect instruction sequences of interest, such as threats by malicious computer data. Training includes distilling the characteristics of known instruction sequences of interest (e.g., intrusion by computer viruses, exploits, worms, or the like) into a set of meta-expressions. At run-time, the instruction sequence detection system combines the minimal set of meta-expressions with efficient computer algorithms for evaluating meta-expressions to detect known instruction sequences of interest, as well as their unknown variants, among an unknown set of instruction sequences. The instruction sequence detection system may provide an appropriate response upon the detection of instruction sequences of interest.

### CROSS-REFERENCE TO RELATED APPLICATIONS

This application claims the benefit of U.S. Provisional Patent Application No. 62/311,840, filed on Mar. 22, 2016, the disclosure of which is herein incorporated by reference in its entirety.

### BACKGROUND

1. Field

The present disclosure relates generally to the field of digital security, and more specifically to detecting activities of interest in one or more instruction sequences, including the detection of malicious activities.

2. Description of Related Art

The proliferation of computing technologies has presented challenges in the field of digital security. As is well known, an electronic device (e.g., a computer operating on an enterprise platform) may be comprised malicious computer data and/or spread malicious computer data to other electronic devices. This may result, for instance, in substantial system disruption and economic loss. One of ordinary skill in the art would appreciate that attacks based on malicious computer data include computer viruses, malware, worms, Trojan horses, bots, intrusions (e.g., unauthorized access), exploits (e.g., escalation of privileges, violation of confidentiality), time-based attacks (e.g., Denial of Service), or the like. The term “threat” is used to describe one or more of these types of attacks.

Conventional digital security technologies may be used to detect and/or remove malicious computer data stored and/or executing on an electronic device. Such digital security technologies can include “anti-virus software”, “malware detection”, “intrusion prevention”, “anti-attack”, firewalls, or the like, though the terms are not identical in meaning. The term “Unified Threat Management” (“UTM”) has been used to describe one or more of these implementations of digital security technologies.

Conventional digital security technologies typically detect threats using signatures that correspond to specific threats. Existing designs under this paradigm are deficient in at least two ways. First, the detection of a threat relies on the a priori knowledge of the specific threat and the availability of a signature for the specific threat. That is, conventional digital security technologies rely on known signatures to detect the presence of a known computer virus, and as a result, conventional digital security technologies often fail to detect threats for which a signature is not yet available or known. For example, conventional digital security technologies may not be able to detect an unknown variation of a known computer virus.

Second, due to the ever-increasing number of known threats, conventional digital security technologies maintain a growing number of signatures. As processes execute on an electronic device, maintained signatures are compared with program images to identify possible threats. In many cases, comparing signatures to program images in this manner uses substantial computing resources. In the context of consumer computers, it should not surprise even the casual computer user that the operation of anti-virus software can cause a computer to become sluggish.

Despite improvements in the field, conventional digital security technologies continue to be limited by these deficiencies, which are consequences of their design.

### BRIEF SUMMARY

An example method for detecting an instruction sequence of interest includes, at an electronic device having one or more processors, identifying a process executing on the electronic device. The method further includes obtaining, using the one or more processors, a representation of a virtual address space of the process. In some examples, the representation is indicative of one or more instruction sequences to be performed by the one or more processors of the electronic device. The method further includes generating, using the one or more processors, a data segment based on the representation. In some examples, the data segment comprises a plurality of integers. The method further includes determining, using the one or more processors, whether a meta-expression including a plurality of ordered integers appears in the data segment. In some examples, the meta-expression corresponds to an instruction sequence of interest. The method further includes, if the meta-expression appears in the data segment, initiating an operation.

### DESCRIPTION OF THE FIGURES

FIG. 1 depicts a virtual address space according to an embodiment of the present invention

FIG. 2 depicts an exemplary process for detecting instruction sequences of interest according to an embodiment of the present invention.

FIG. 3 depicts a process for training a Unified Threat Management System (UTMS) according to an embodiment of the present invention.

FIG. 4 depicts an exemplary process for implementing a distance function according to an embodiment of the present invention.

FIGS. 5(A)-(F) depict exemplary sequences of integers according to an embodiment of the present invention.

FIGS. 6(A)-(C) depict exemplary sequences of integers according to an embodiment of the present invention.

FIG. 7 depicts exemplary sequences of integers according to an embodiment of the present invention.

FIG. 8 depicts exemplary sequences of integers according to an embodiment of the present invention.

FIG. 9 depicts an exemplary computing system for detecting instruction sequences of interest according to an embodiment of the present invention.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

The embodiments described herein include techniques for detecting instruction sequences of interest. Exemplary instruction sequences of interest include, but are not limited to, instruction sequences that correspond to computer viruses, malware, worms, Trojan horses, bots, intrusions (e.g., unauthorized access), exploits (e.g., escalation of privileges, violation of confidentiality), timed-based attacks (e.g., Denial of Service), or the like.

### 1. Overview

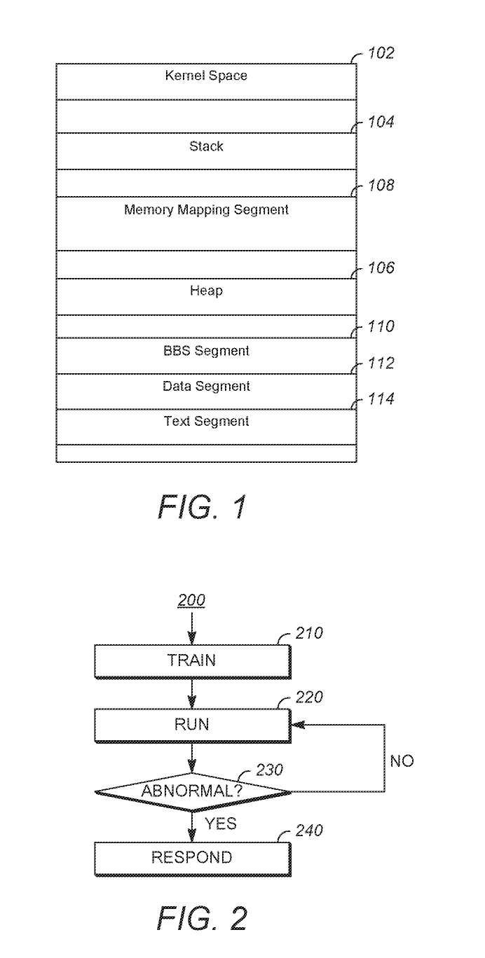

Examples of the present invention are directed to virtual address spaces. Generally, a virtual address space is a set (e.g., one or more) of ranges of addresses (e.g., virtual addresses) made available to a process, for instance, by an operating system. Each process executing on an electronic device is assigned a respective virtual address space. With reference to FIG. 1, a virtual address space includes multiple partitions: a kernel space 102 and user space. Kernel space 102 is reserved for the kernel and is not discussed further in the interest of brevity. User space is further partitioned into segments including an execution stack 104, a heap 106, a memory mapping segment 108 (including dynamic links), a BSS segment 110 (e.g., for storing variables not initialized in source code or pointers thereto), a data segment 112 (e.g., for storing variables initialized in source code or pointers thereto), and a code segment 114 (e.g., for storing a program image or a pointer thereto).

In operation, the execution stack 104 stores temporary variables and function parameters. When a function is called, a stack frame is pushed onto the execution stack 104 whi1e the function executes, and the frame popped (e.g., removed) when the function returns. In this manner, the execution stack 104 serves as a last-in-first-out (LIFO) mechanism by which various operations are performed. A pointer is used to track the “top” of the stack during operation and the size of the stack is typically fixed in size. On the other hand, the heap 106 stores variables yet persists across multiple function calls such that stored variables may be accessed by a process globally. The size of the heap may be adjusted using various allocation functions (e.g., malloc( ) calloc( ). The memory mapping segment 108 includes one or more dynamic links for accessing one or more libraries (e.g., DLLs) as required during operation.

FIG. 2 illustrates exemplary process 200 for detecting instruction sequences of interest. For purposes of this disclosure, the term “Unified Threat Management System” (UTMS) is used to describe computer security technologies that carry out process 200, regardless of whether the technologies are provided in software form (e.g., as a software package) or in hardware form (e.g., an application-specific circuit or device). Within process 200, block 210 may be referred to as a training process, while blocks 220-240 may be collectively referred to as a run-time process.

At block 210, a UTMS is trained to identify one or more instruction sequences of interest. By way of example, the UTMS may be provided with a representation of a virtual address space of a process that corresponds to a particular, known threat. The representation may, for instance, include or be indicative of instructions corresponding to the known threat. In some examples, the representation is obtained using an application configured to capture the representation during execution of the process, such as a stack trace function. The representation may be indicative of one or more instruction sequences to be performed by the one or more processors of the electronic device. Further, the representation may be indicative of instruction sequences associated with any number of threads of the process and/or further may be associated with instruction sequences configured for multi-threaded operation (e.g., hyperthreading). Any known data structure may be used to implement the representation, including but not limited to a table, a linked list, or a combination thereof, and in some examples, may be obtained in response to a context switch, for instance, to the process associated with the virtual address space.

During training, the UTMS identifies, from the training representation, instruction sequences and/or data (e.g., data associated with the instruction sequences) that can be subsequently used to identify the presence of the same instruction sequences of interest in another, unknown set of operations. In addition, by way of processing at block 210, the UTMS also becomes able to identify the presence of threats that are related to the threat that was previously provided in the training instructions (i.e., a variant).

At block 220, the UTMS monitors a virtual address space to determine whether the (trained and related) instruction sequences of interest are present in the virtual address space. For example, the UTMS may monitor the virtual address space to determine if a process corresponding to the virtual address space intends to execute instructions associated with malicious activity. Monitoring the virtual address space in this manner may, for instance, include monitoring an execution stack of the virtual address space, a heap of the virtual address space, a memory mapping segment, and/or any other portion of a virtual address space. In some examples the UTMS may monitor portions of one or more additional virtual address spaces, such as those linked to the virtual address space by way of one or more dynamic links.

At decision block 230, the UTMS determines whether the monitored virtual address space is normal or abnormal. An abnormal virtual address space is one in which the UTMS has identified one or more instruction sequences of interest. If an abnormal instruction sequence is found, processing proceeds to block 240, where the UTMS provides (e.g., generates) one or more appropriate responses. Providing an appropriate response may include providing a user or system alert and/or may include terminating one or more threads of the process associated with the virtual address space. In another example, providing an appropriate response may include terminating all threads of the process associated with the virtual address space. In yet another example, providing an appropriate response may include terminating at least one thread of each of a plurality of processes. In some examples, the UTMS may instruct an OS kernel to terminate threads and/or processes. In other examples, the UTMS may include a dynamic link library to which the process is linked and may terminate threads and/or processes directly. If no abnormal instruction sequences are found, processing returns to block 220, and the UTMS monitors another virtual address space, for instance, of a virtual address space. As described, the UTMS may monitor a virtual address space responsive to a context switch. In this manner, the UTMS may monitor (e.g., sequentially monitor) any number of processes executing on an electronic device.

In the discussion below, the threat of computer viruses is used as an exemplary instruction sequence of interest for sake of simplicity. Process 200 (FIG. 1), however, is not so limited in some examples. Rather, process 200 may be used by a UTMS to manage many other kinds of instruction sequences of interest, as discussed above. Coincidentally, the (exemplary) discussion of computer viruses highlights the substantial advantages of process 200 in a way that is understandable to many computer users including those having ordinary skill in the art.

At present, over 2 million computer viruses are known to exist. The exact count varies between 2.5 million and 8 million, because different sources of authority catalogue computer viruses differently. At block 210 of process 200, a UTMS may be provided with an instruction sequence that reflects one or more attacks associated with one or more known computer viruses. At the completion of block 210, the UTMS becomes trained to detect the presence of those one or more computer viruses, as well as their respective variants, in a virtual address space. At blocks 220-240, the UTMS monitors a virtual address space for the presence of those one or more computer viruses and their variants. In this way, the UTMS is able to manage attacks that are based known threats and their unknown variants.

Process 200 is notable in at least two ways. First, block 210 produces bounded sequences of data that can be used to detect all known computer viruses and their respective variants. Thus, a UTMS using process 200 need not necessarily rely on the a priori knowledge of a specific computer virus in order to detect the computer virus in a virtual address space during operation. Second, bounded sequences of data provided at block 210 are efficient in structure and in size when compared to known computer viruses signature files used by conventional computer anti-virus technologies. Specifically, it has been determined that bounded sequences of data totaling less than 200 (8-bit) bytes are sufficient to identify most, if not all, computer viruses presently known to exist, using process 200. This size stands in stark contrast to the size of conventional computer viruses signature files, which typically range from 50 megabytes (MB) to 300 MB in size. To put into perspective, the size of 50 MB is larger than the size of 200 (8-bit) bytes by 5 orders of magnitude. Thus, tremendous computational efficiencies can be realized during operation of a UTMS using process 200.

### 2. Training

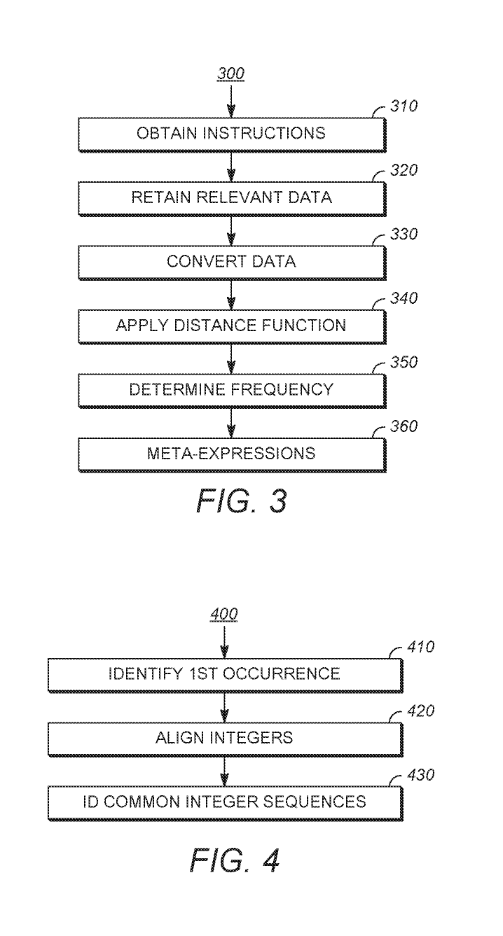

FIG. 3 illustrates an exemplary process 300 for training a UTMS. The process 300, may for instance, be used to implement block 210 (FIG. 1). At block 310, a process is identified, and a representation of a virtual address space of the process is obtained. The representation may be obtained, for instance, using any number of functions, including but not limited to, stack trace functions and the like. As described, the representation may include or be indicative of instruction sequences of the process. The concept of “instruction” is well known in the art and is not detailed here. The term “instruction” may include instructions of one or more instruction sets, such as an instruction set of an x86 processor.

In some examples, the representation obtained at block 310 includes (or indicates) an instruction sequence of interest for purposes of training a UTMS. In the present example, the instruction sequence of interest is the presence of instructions associated with a computer virus in the virtual address space of a process. Thus, the instructions provided to block 310 may be indicative of an attack on an electronic device using a computer virus.

Optionally, in some examples, representations of additional virtual address spaces are also obtained. The additional virtual address spaces may, for instance, be those associated with the virtual address space by way of one or more dynamic links. While operation is described herein with respect to a representation of a single virtual address space, it will be appreciated that described examples apply analogously to analysis of representations of multiple virtual address spaces. In this manner, the UTMS may be trained on instruction sequences that are not contained within a single virtual address space, but rather are included in, call on, or are otherwise associated with multiple virtual address spaces.

In some examples, only particular portions of an instruction sequence are relevant to detecting instruction sequences of interest. Accordingly, at block 320, the relevant portions of an instruction sequence are retained, and extraneous information is discarded. By way of example, one or more instructions associated with one or more of the execution stack, heap, memory mapping segment, or any other portion of a virtual address space may be discarded. Additionally or alternatively, portions of instructions may be discarded. As an example, operands and/or pointers may be discarded. As another example, instructions of a particular type may be discarded. Opcodes, for instance, may be used to identify a type of one or more instructions, and instructions having opcodes of a particular type (e.g., NOP) may be discarded. The output of block 320 is referred to as a “relevant instruction sequence”.

At block 330, the relevant instruction sequence from block 320 is converted, bitwise, into integers, thereby producing one or more data segments. Each data segment may include a sequence of integers that corresponds to a subset of the information obtained at block 310. In one embodiment, 8-bit integers are used. Instructions that span less than 8-bits are converted to 8-bit representation by padding zeros to the most significant output bits. For example, block 320 may convert bits “100” to “0000 0100”. Instructions for operations that span more than 8-bits are converted into multiple 8-bit segments. For example, block 320 converts bits “0001 0010 0100 1000” to “0001 0010” and “0100 1000”.

As used here, the term “sequence” describes a list of ordered elements. It should be appreciated that the ordering of elements within sequences of integers provided at block 330 are derived from the ordering and adjacency of relevant portions of instruction sequences processed at blocks 310-320. Put another way, to the extent that an instruction sequence of interest produces a characteristic response in execution of a process, that response is captured by way of implementation of blocks 310-330. The response is further distilled in the implementation of blocks 340-360, discussed below, such that the response becomes useful for detecting instruction sequences of interest in an unknown set of instruction sequences.

At block 340, a distance function is used to identify characteristics from the sequences of integers produced by block 330. In some examples, the distance function is performed by comparing sequences of integers for different instructions and/or instruction sequences. By way of example, a sequence of integers produced by block 330 (based on a first set of instructions from block 320) is compared against the next, adjacent sequence of integers produced by block 330 (based on the next, adjacent set of instructions from block 320).

Conventional distance functions, such as string distance functions, are well known in the art and are not discussed in detail here. As an example, a conventional string distance function may be used to determine that the strings “a b c” and “z b c” have a distance of 1, because the strings vary only in that “a” in the former is replaced with “z” in the latter, and represents the sole difference between the two strings. The instruction sequences produced by block 310 lend themselves to comparison by distance functions because block 330 produces sequences of integers, which may be treated as individual elements by a distance function. Conventional string distance functions, however, do not provide distance metrics that are sufficient for detecting instruction sequences of interest. For example, the knowledge that two strings differ by a distance of 1 provides little useful information for computer virus detection.

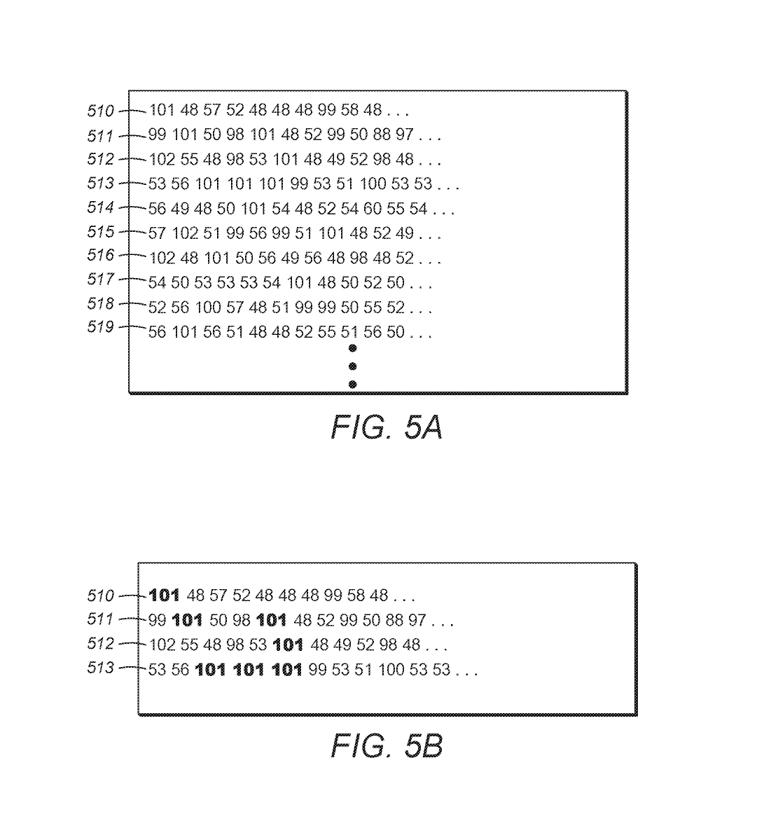

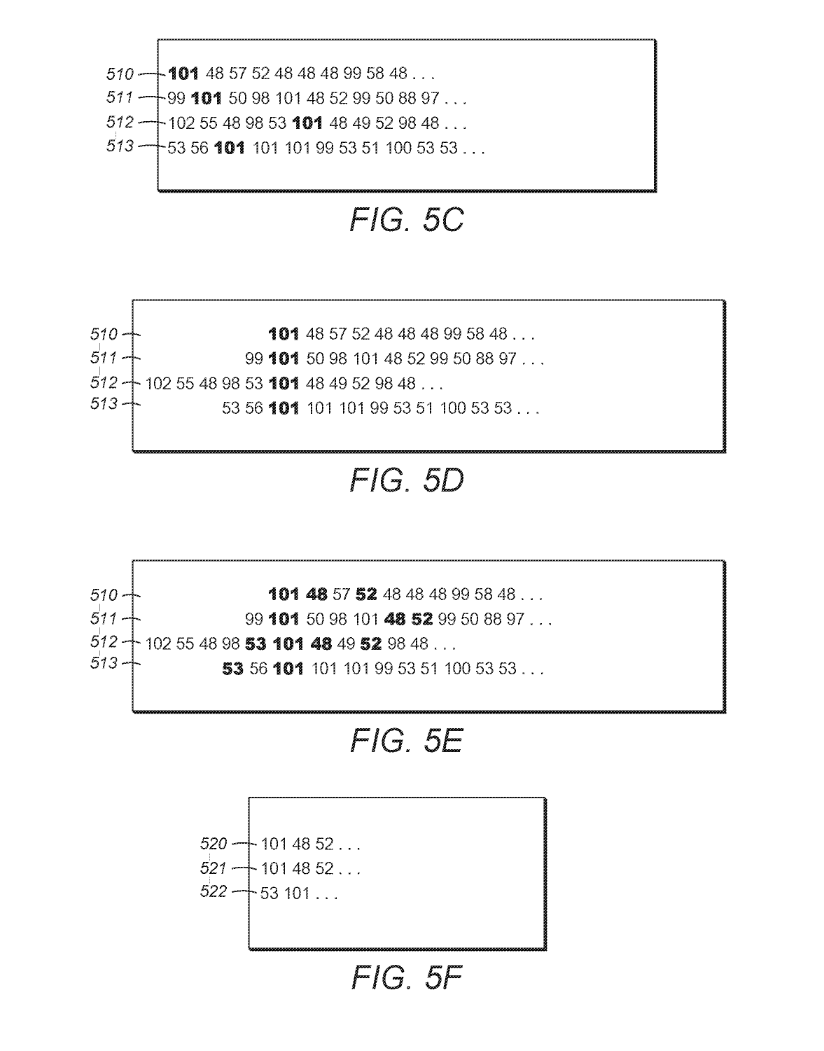

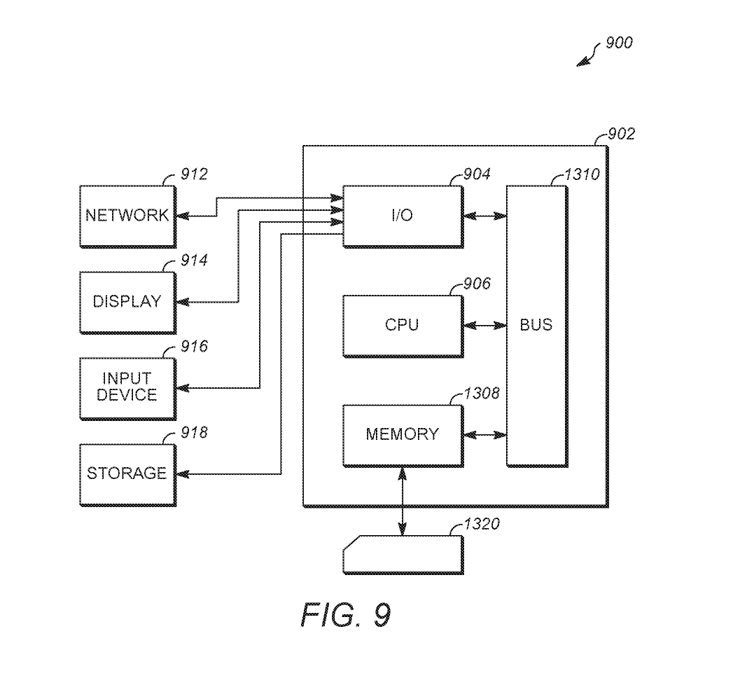

In one embodiment, block 340 performs a custom distance function, described below, that produces reduced sequences of integers that support the detection of instruction sequences of interest. For the sake of simplicity, the custom distance function of block 340 is discussed with reference to FIGS. 4 and 5. FIG. 4 illustrates exemplary process 400 for performing the custom distance function, in one embodiment. FIG. 9 illustrates exemplary sequences of integers as they are processed by exemplary process 800, in the one present embodiment.

Turning to FIG. 4, at block 410, the custom distance function identifies integers that appear within adjacent pairs of sequences of integers produced by block 340 (FIG. 3). FIG. 5A illustrates exemplary sequences of integers 510-519. FIG. 5B illustrates exemplary integer “101”, which appears in at least pairs of adjacent sequences of integers 510-511, 511-512, and 512-513. (Note, sequences of integers 514-519 are not illustrated for simplicity). At block 410, the custom distance function also identifies the first instance of an identified integer in pairs of adjacent sequences of integers. FIG. 5C illustrates the first instance of “101” being identified in adjacent sequences of integers 510-511, 511-512, and 512-513.

At block 420 (FIG. 4), the custom distance function aligns the first instances of the identified integer in a pair of adjacent sequences of integers. FIG. 5D illustrates the alignment of the first instances of “101” in pairs of adjacent sequences of integers 510-511, 511-512, and 512-513.

At block 430 (FIG. 4), a reduced sequence of integers may be created, under some conditions, for a pair of adjacent sequences of integers. A reduced sequence of integers is created (for a pair of adjacent sequences of integers) if one or more of the integers that are common to the pair of adjacent groups of sequences of integers satisfy two conditions. That is, a reduced sequence of integers is created if one or more of the integers that are comment to the pair of adjacent groups of sequences: (i) appear in the same order in the pair of adjacent sequences of integers, and (ii) has positions in the pair of sequences of integers that are within a first threshold distance. In one embodiment, the first threshold distance is four. If created, a reduced sequence of integers would comprise integers that satisfy requirements (i) and (ii) stated above (with respect to a pair of adjacent sequences of integers).

For example, with reference to FIG. 5E, when the first instance of “101” is aligned between sequences of integers 510 and 511, the integers “48” and “52” satisfy requirements (i) and (ii) stated above. Specifically, the integers “101”, “48”, and “52” appear in the same order in both sequences of integers 510 and 511. Further, the integer “48” appears in both sequences of integers 510 and 511 within the first threshold distance (of four, in the present embodiment). Thus, as shown in FIG. 5F, reduced sequence of integers 520 is created, and includes the sequence of integers “101 48 52”. Also as shown in FIG. 5F, the integers “101” “48” and “52” in sequences of integers 511 and 512 also satisfy requirements (i) and (ii) stated above. Thus, reduced sequence of integers 521 is created, and includes the sequence of integers “101 48 52”. Also as shown in FIG. 5F, the integers “53” and “101” in sequences of integers 512 and 513 also satisfy requirements (i) and (ii) stated above. Thus, reduced sequence of integers 522 is created, and includes the sequence of integers “53 101”.

Blocks 410-430 repeat for other integers that appear within at least a pair of adjacent sequences of integers. For example, the integer “48” also appears in at least one pair of adjacent sequences of integers among sequences of integers 510-519. Thus, blocks 410-430 are repeated for 4-bit integer “48”.

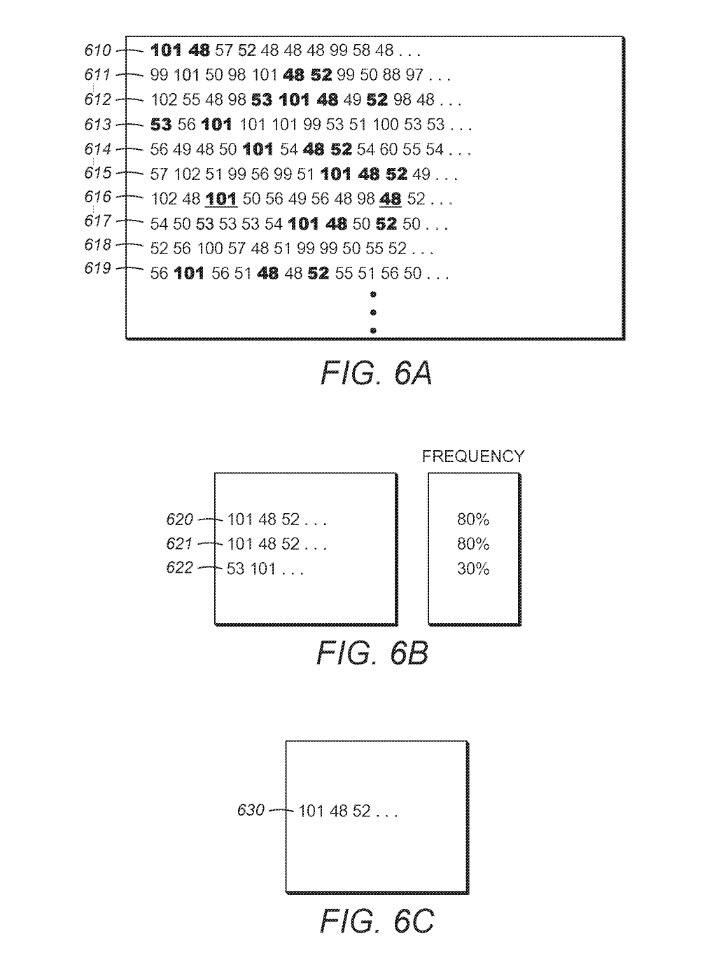

At the completion of block 430 (which in some examples is an exemplary string function carried out in block 340 of FIG. 3), processing proceeds to block 350 (FIG. 3). At block 350, the frequency at which a reduced sequence of integers appears, within a second threshold distance, in the sequences of integers created at block 330 is determined. The first and second threshold distances may be the same or may be different. In one embodiment, the second threshold distance is four. FIG. 6A illustrates exemplary sequences of integers 510-519 created by block 330. In addition, FIG. 6B illustrates the appearance of reduced sequences of integers 520-522 (FIG. 5F) within sequences of integers 510-519. As shown, reduced sequence of integers 520 (“101 48 52”) appears (within the exemplary second threshold distance of four) in eight out of the ten sequences of integers 510-519. Thus, a frequency of 40% is associated with reduced sequence of integers 520. For the same reason, a frequency of 40% is associated with reduced sequence of integers 521. Note, reduced sequences of integers 520 and 521 do not appear within the second threshold distance (of four, in this example) in sequence of integers 516, because the integers “101” and “48” are separated by more than four positions in integer sequence 516. Also as shown, reduced sequence of integers 522 (“53 101”) appears (within the exemplary second threshold distance of four) in three out of the ten sequences of integers 510-519. Thus, a frequency of 30% is associated with reduced sequence of integers 522. The frequencies associated with reduced sequences of integers 520-521 are illustrated in FIG. 6B. These values, which indicate the frequencies with which reduced sequences of integers appear in order within a threshold distance in sequences of integers, may be referred to by the term “confidence values”.

At block 360 (FIG. 3), reduced sequences of integers having confidence values below a threshold confidence value are discarded. In one embodiment, the threshold confidence value is between 40-50%. FIG. 6C illustrates the discarding of reduced sequence of integers 522. In addition, reduced sequences of integers 520 and 521 (which are the same) are de-duplicated and maintained as reduced sequence of integers 630. For purposes of this disclosure, each reduced sequence of integers 630 may be referred to as a “meta-expression”.

Meta-expression 630 represents the information that is sufficient to detect an instruction activity of interest within a virtual address space. Specifically, meta-expression 630 is sufficient to detect the instruction sequence represented by the initial input to process 300 (FIG. 3). Recall that the input to process 300 (FIG. 3) is a set of instructions associated with an attack, such as an attack using a computer virus.

Process 300 (FIG. 3) may be repeated for other types of instruction sequences of interest. For example, process 300 may be performed using an instruction sequence that indicates an attack by computer worm A to identify a meta-expression for detecting computer worm A and variants of computer worm A. Process 300 may be performed again using instruction sequences that indicate an attack by computer exploit B to identify a meta-expression for detecting computer exploit B and its variants. Indeed, process 300 may be repeated for different computer viruses, malware, worms, Trojan horses, bots, intrusions (e.g., unauthorized access), exploits (e.g., escalation of privileges, violation of confidentiality), time-based attacks (e.g., Denial of Service), or the like, that are known to exist, in order to determine meta-expressions that can be used to identify malicious instructions, as well as their respective variants.

Importantly, it has been determined that many different malicious instruction sequences share the same meta-expressions. That is to say, two different instruction sequences of interest (such as a known computer virus A and a known computer virus B) may share the same meta-expression and therefore are detectable using a single meta-expression. Further, a meta-expression that is generated from an existing computer virus, for example, can be used to detect all variations of the existing computer virus, regardless of the permutations, sizes, or characteristics of the variations (i.e., even if the variations are unknown). Only a completely new type of computer virus, and not a variation on an existing computer virus, would not be detected by the existing meta-expression. In this way, a handful of meta-expressions are sufficient to identify many, if not all, of the known computer viruses (which number between 2.5 to 4 million, depending on the source of authority), as well as their respective variants.

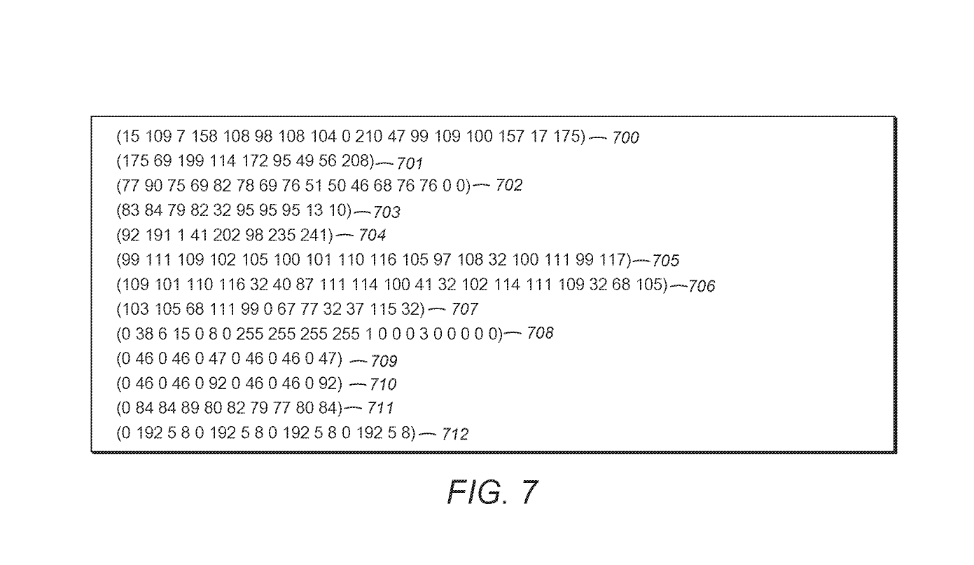

FIG. 7 illustrates 9 exemplary meta-expressions 700-712. Meta-expressions 700-712 span less than 200 (8-bit) bytes in total, and can be used to detect all variations of the existing computer virus as discussed above. This size stands in stark contrast to the size of a typical database of anti-virus signatures, which is on the order of 50 MB or more. The structure and minimal size of these meta-expressions provide tremendous computational efficiencies as compared to conventional computer security technologies.

### 3. Run-Time

The efficiency with which instruction sequences of interest can be detected using the meta-expressions provided by process 300 are now discussed. At the completion of process 300 (which is an exemplary UTMS training process carried out at block 210 of FIG. 1), processing proceeds to block 220 of FIG. 1. At block 220, a UTMS utilizes meta-expressions to analyze a virtual address space, and to detect whether the virtual address space is normal or abnormal. Processing at block 220 begins with obtaining a representation of the virtual address space. For this purpose, the techniques of block 310 (FIG. 3) may be used. As described, the representation may be obtained, for instance, using a stack trace function. Next, instruction sequences of the representation are filtered for relevant information. For this purpose, the techniques of block 320 (FIG. 3) may be used. Next, the relevant instruction sequences are converted into sequences of integers. The bit size of the integers used during run-time are the same as the bit size of the integers used during training in some examples. In one embodiment, the integers are 4 bits in size. In another embodiment, the integers are 8 bits in size. For purposes of converting relevant instruction sequences into sequences of integers, the techniques of block 330 (FIG. 3) may be used. Recall that in some examples, the UTMS may further analyze additional virtual address spaces to determine if the virtual address space is normal or abnormal. Accordingly, the techniques of blocks 310, 320, and 330 may simultaneously be applied to plurality of virtual address spaces.

The sequences of integers produced by block 330 are compared against one or more meta-expressions to determine if the analyzed virtual address space is normal or abnormal. An analyzed virtual address space is considered “abnormal” when two criteria are satisfied: (i) each integer in a meta-expression is present in the sequence of integers that corresponds to the virtual address space, and (ii) the sequence of integers appears in the same order in both the corresponding sequence of integers and the meta-expression. Notably, a virtual address space is considered normal if condition (i) fails to hold true. (The failure of condition (ii) is less useful because a sequence of integers may have multiple instances of a particular integer, and all of the instances must fail condition (ii) in order for condition (ii) to fail as a whole.)

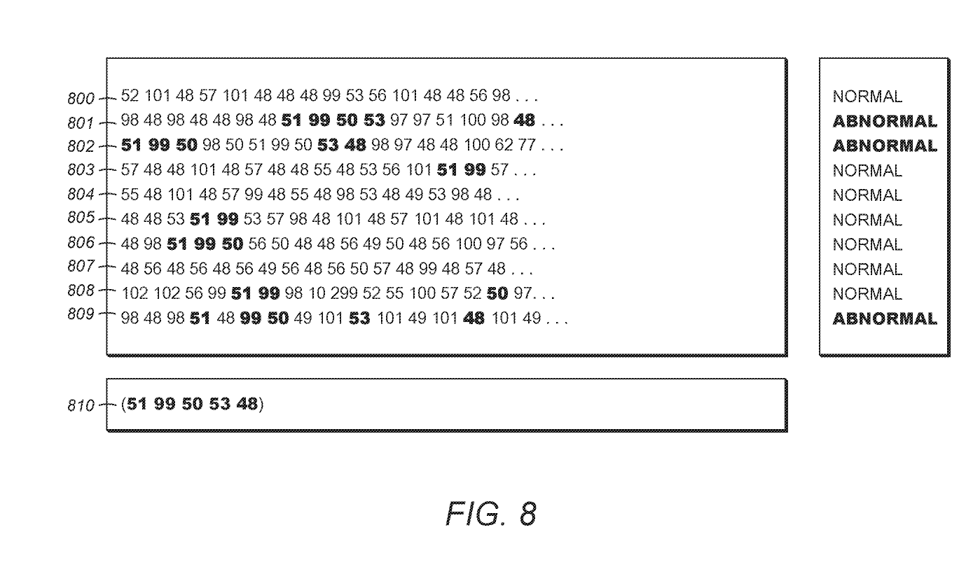

When abnormal traffic is detected, the UTMS follows decision block 230 to block 240, where one or more appropriate responses are generated. When a normal virtual address space is detected, the UTMS returns to block 220 and analyzes additional virtual address spaces of one or more other processes and/or subsequently the same process. Blocks 210-230 are discussed with reference to FIG. 8. FIG. 8 illustrates exemplary sequences of integers 800-809 and exemplary meta-expression 810. Meta-expression 810 may be one of the meta-expressions that were provided (e.g., generated) during training (block 210 of FIG. 1). The length of meta-expression 810 is shortened for simplicity. As shown, sequences 801, 802, and 809 contain all of the integers of meta-expression 810, in the same order in which the integers appear in meta-expression 810. Thus, sequences of integers 801, 802, and 809 are associated with virtual address spaces considered to be abnormal. Sequences of integers 800 and 803-808 do not contain all of the ordered integers of meta-expression 810. Thus, sequences of integers 800 and 803-808 are associated with virtual address spaces that are considered normal.

As is evident from the preceding discussion, at block 220, a UTMS performs many integer comparisons. Thus, optimization of integer comparisons is important to the efficiency of the UTMS. Recall that a virtual address space is considered to be normal at the first instance in which an integer in the meta-expression is absent in the sequence of integers that correspond to the virtual address space. Thus, the performance of the UTMS is improved if an early “normal” determination can be made. To this end, it is beneficial to structure the technique of block 220 such that the integer comparisons between a sequence of integers and a meta-expression terminates as soon as one integer from the meta-expression is identified as being absent in the sequence of integers.

In one embodiment, block 220 employs a nested computer programming language expression that returns an overall value of “failure” (e.g., a Boolean value) when any one of the nested levels returns a “false” condition. Thus, as soon as a UTMS identifies the absence of one integer (at any one of the nested levels), processing of the entire nested computer programming language expression terminates. The corresponding virtual address space is thus identified as being normal (in which case, no additional threat detection is necessary), and a subsequent virtual address space can be analyzed. For example, the LISP computer programming language allows for a nested expression in the form ((((A) (B)) (C)) (D)) that returns an overall value of “failure” if any one of expressions (A), (B), (C), and/or (D) is “false”. In this example, the expression (A) may query whether the first integer in a meta-expression appears in a sequence of integers, and the expression (B) may query whether the second integer in the meta-expression appears in the sequence of integers, so forth.

At block 240, appropriate responses may be generated. One appropriate response may be a user or system alert that indicates the presence of an instruction sequence of interest. Another appropriate response may be to terminate one or threads of a process associated with an abnormal virtual address space. Yet another appropriate response may include terminating at least one thread of each of a plurality of processes.

Portions of process 200 (FIG. 1) may be implemented in exemplary computing system 900 illustrated in FIG. 9. In some embodiments, computing system 900 is an electronic device, including but not limited to, a router, gateway, firewall, mobile device, desktop computer, laptop computer, cellular phone, tablet, or any combination thereof. In some embodiments, computing system 900 is a dedicated microprocessor, such as a cryptoprocessor. Notably, the training aspects of process 200 (i.e., block 210) and the run-time aspects of process 200 (i.e., blocks 220-240) may be implemented onto the same, or onto different computing systems.

As shown in FIG. 9, the computing system 900 includes a computer motherboard 902 with bus 910 that connects I/O section 904, one or more central processing units (CPU) 906, and a memory section 908 together. Memory section 908 may have memory module 920 related to it. Memory module 920 may be, for example, non-volatile memory (e.g., NAND flash, NOR flash) and/or volatile memory, and further may comprise a removable memory device in some examples. The I/O section 904 is connected to network interface 912, which receives and/or transmits network packets. I/O section 904 may be connected to display 914, input device 916, and/or storage unit 918. Memory section 908, memory module 920, and/or storage unit 922 can store (e.g., tangibly embody) computer-readable medium that contain computer-executable instructions and/or data for performing any one of the above-described processes using CPU 906. The computer-executable instructions may be written, for example, in a general-purpose programming language (e.g., LISP, C) or in a specialized application-specific language. Input device 916 may be a USB port supporting input from USB-compliant devices, such as a keyboard, a mouse, a memory stick, or the like. At least some values based on the results of the above-described processes can be saved into memory such as memory 908, memory module 920, and/or disk storage unit 918 for subsequent use.

Portions of process 200 (FIG. 1) also may be implemented into a processor by way of specifically arranged integrated circuits (e.g., application-specific integrated circuits). In some embodiments, the integrated circuit can be part of the main processor of a device, such as the main processor of a cellular phone. In some embodiments, the integrated circuit can be part of an auxiliary processor of a device, such as a processor that is connected to the motherboard of a laptop. The integrated circuits can contain computer-executable instructions and/or data for perform any one of the above-described processes. The computer-executable instructions may be written, for example, in a specialized application-specific (e.g., processor-specific) language.

In some embodiments, computer-executable instructions based on the C programming language that total less than 1 MB are sufficient to carry out process 200 (FIG. 1). Execution of these computer-executable instructions requires no more than 300 kilobytes (16-bit bytes) of run-time memory (e.g., random access memory). Modern computing systems and/or processors are well capable processing computer-executable instruction of these sizes.

Although only certain exemplary embodiments have been described in detail above, those skilled in the art will readily appreciate that many modifications are possible in the exemplary embodiments without materially departing from the novel teachings and advantages of this disclosure. For example, aspects of embodiments disclosed above can be combined in other combinations to form additional embodiments. Accordingly, all such modifications are intended to be included within the scope of this technology.

What is claimed is:

1. A method for detecting an instruction sequence of interest, the method comprising:
at an electronic device having one or more processors:
identifying a process executing on the electronic device;
obtaining, using the one or more processors, a representation of a virtual address space of the process, wherein the representation is indicative of one or more instruction sequences to be performed by the one or more processors of the electronic device;
generating, using the one or more processors, a data segment based on the representation, wherein the data segment comprises a plurality of integers;
determining, using the one or more processors, whether a meta-expression including a plurality of ordered integers appears in the data segment, wherein the meta-expression corresponds to an instruction sequence of interest; and
if the meta-expression appears in the data segment, initiating an operation.

2. The method of claim 1, wherein obtaining, using the one or more processors, a representation of a virtual address space of the process comprises:
identifying a context switch; and
responsive to identifying the context switch, obtaining the representation of the virtual address space of the process.

3. The method of claim 2, wherein identifying the context switch comprises:
identifying a context switch associated with the process.

4. The method of claim 1, wherein obtaining, using the one or more processors, a representation of a virtual address space of the process comprises:
obtaining a first representation of the virtual address space; and
obtaining a second representation of the virtual address space, and
wherein generating, using the one or more processors, a data segment based on the representation comprises:
generating the data segment based on the first and second representations.

5. The method of any of claim 1, wherein obtaining, using the one or more processors, a representation of a virtual address space of the process comprises:
obtaining the representation using a stack trace function.

6. The method of any of claim 1, wherein initiating an operation comprises:
causing the process to be terminated.

7. The method of claim 6, wherein causing the process to be terminated comprises:
causing the process to be terminated using an operating system kernel executing on the electronic device.

8. The method of any of claim 1, wherein the representation corresponds to each of a plurality of threads of the process.

9. The method of claim 8, wherein initiating the operation comprises:
terminating execution of each of the plurality threads of the process.

10. The method of claim 8, wherein initiating the operation comprises:
selectively terminating each of the plurality of threads of the process.

11. The method of claim 1, wherein the representation is at least one of a table, a linked list, or a combination thereof.

12. The method of claim 1, wherein the representation is indicative of a plurality of data associated with the one or more instruction sequences.

13. A non-transitory computer readable medium encoded with program instructions that, when executed by one or more processors of an electronic device cause the processor to execute a method comprising:
identifying a process executing on the electronic device;
obtaining, using the one or more processors, a representation of a virtual address space of the process, wherein the representation is indicative of one or more instruction sequences to be performed by the one or more processors of the electronic device;
generating, using the one or more processors, a data segment based on the representation, wherein the data segment comprises a plurality of integers;
determining, using the one or more processors, whether a meta-expression including a plurality of ordered integers appears in the data segment, wherein the meta-expression corresponds to an instruction sequence of interest; and
if the meta-expression appears in the data segment, initiating an operation.

14. The non-transitory computer readable medium of claim 13, wherein obtaining, using the one or more processors, a representation of a virtual address space of the process comprises:
identifying a context switch; and
responsive to identifying the context switch, obtaining the representation of the virtual address space of the process.

15. The non-transitory computer readable medium of claim 14, wherein identifying the context switch comprises:
identifying a context switch associated with the process.

16. The non-transitory computer readable medium of claim 13, wherein obtaining, using the one or more processors, a representation of a virtual address space of the process comprises:
obtaining a first representation of the virtual address space; and
obtaining a second representation of the virtual address space, and
wherein generating, using the one or more processors, a data segment based on the representation comprises:
generating the data segment based on the first and second representations.

17. The non-transitory computer readable medium of claim 13, wherein obtaining, using the one or more processors, a representation of a virtual address space of the process comprises:
obtaining the representation using a stack trace function.

18. The non-transitory computer readable medium of claim 13, wherein initiating an operation comprises:
causing the process to be terminated.

19. The non-transitory computer readable medium of claim 18, wherein causing the process to be terminated comprises:
causing the process to be terminated using an operating system kernel executing on the electronic device.

20. The non-transitory computer readable medium of claim 13, wherein the representation corresponds to each of a plurality of threads of the process.

21. The non-transitory computer readable medium of claim 20, wherein initiating the operation comprises:
terminating execution of each of the plurality threads of the process.

22. The non-transitory computer readable medium of claim 20, wherein initiating the operation comprises:
selectively terminating each of the plurality of threads of the process.

23. The non-transitory computer readable medium of claim 13, wherein the representation is at least one of a table, a linked list, or a combination thereof.

24. The non-transitory computer readable medium of claim 13, wherein the representation is indicative of a plurality of data associated with the one or more instruction sequences.

25. An electronic device for detecting an instruction sequence of interest, comprising:
one or more processors;
memory; and
one or more programs, wherein the one or more programs are stored in the memory and configured to be executed by the one or more processors, the one or more programs including instructions for:
identifying a process executing on the electronic device;
obtaining, using the one or more processors, a representation of a virtual address space of the process, wherein the representation is indicative of one or more instruction sequences to be performed by the one or more processors of the electronic device;
generating, using the one or more processors, a data segment based on the representation, wherein the data segment comprises a plurality of integers;
determining, using the one or more processors, whether a meta-expression including a plurality of ordered integers appears in the data segment, wherein the meta-expression corresponds to an instruction sequence of interest; and
if the meta-expression appears in the data segment, initiating an operation.

26. The electronic device of claim 25, wherein obtaining, using the one or more processors, a representation of a virtual address space of the process comprises:
identifying a context switch; and
responsive to identifying the context switch, obtaining the representation of the virtual address space of the process.

27. The electronic device of claim 26, wherein identifying the context switch comprises:
identifying a context switch associated with the process.

28. The electronic device of claim 25, wherein obtaining, using the one or more processors, a representation of a virtual address space of the process comprises:
obtaining a first representation of the virtual address space; and
obtaining a second representation of the virtual address space, and
wherein generating, using the one or more processors, a data segment based on the representation comprises:
generating the data segment based on the first and second representations.

29. The electronic device of claim 25, wherein obtaining, using the one or more processors, a representation of a virtual address space of the process comprises:
obtaining the representation using a stack trace function.

30. The electronic device of claim 25, wherein initiating an operation comprises:
causing the process to be terminated.

31. The electronic device of claim 30, wherein causing the process to be terminated comprises:
causing the process to be terminated using an operating system kernel executing on the electronic device.

32. The electronic device of claim 25, wherein the representation corresponds to each of a plurality of threads of the process.

33. The electronic device of claim 32, wherein initiating the operation comprises:
terminating execution of each of the plurality threads of the process.

34. The electronic device of claim 32, wherein initiating the operation comprises:
selectively terminating each of the plurality of threads of the process.

35. The electronic device of claim 25, wherein the representation is at least one of a table, a linked list, or a combination thereof.

36. The electronic device of claim 25, wherein the representation is indicative of a plurality of data associated with the one or more instruction sequences.
